(19) United States
(12) Patent Application Publication
(10) Pub. No.: US 2026/0173059 A1
(43) Pub. Date: Jun. 18, 2026

(54) UE Capability Reporting and Configuration for Dynamic UL Tx Switching for More Than 2 Bands

(71) Applicant: Apple Inc., Cupertino, CA (US)

(72) Inventors: Ankit BHAMRI, Haar (DE); Wei ZENG, Saratoga, CA (US); Yang TANG, San Jose, CA (US); Qiming LI, Beijing (CN); Chunhai YAO, Beijing (CN); Dawei ZHANG, Saratoga, CA (US); Haitong SUN, Saratoga, CA (US); Oghenekome OTERI, San Diego, CA (US); Weidong YANG, San Diego, CA (US)

(21) Appl. No.: 19/126,432

(22) PCT Filed: Nov. 3, 2022
(86) PCT No.: PCT/CN2022/129629

§ 371 Date: May 1, 2025

(51) Int. Cl. H04W 72/0457; H04W 8/24; H04W 72/21

(52) U.S. Cl. CPC H04W 72/0457; H04W 8/24; H04W 72/21

(57) ABSTRACT

A user equipment (UE) is configured to report UE capability information related to uplink (UL) transmission (Tx) switching to a network, wherein the UE capability information comprises an indication that the UE supports a 3 or 4 band combination for UL Tx switching and an indication that the UE supports simultaneous Tx on at least one two-band combination from the 3 or 4 band combination, receive, from the network, a UL Tx switching configuration based on at least the UE capability information and perform UL transmissions based on the UL Tx switching configuration.

### TECHNICAL FIELD

This application relates generally to wireless communication systems, and in particular relates to UE capability reporting and configuration for dynamic UL Tx switching for more than 2 bands.

### BACKGROUND

Uplink (UL) transmission (Tx) switching was introduced in 3GPP New Radio (NR) Rel-16 to improve UL coverage for 5G user equipment (UE). When UL Tx switching is enabled for a 5G UE with at least two UL Tx chains/channels (2Tx), the UE can switch between a first mode, in which the UE transmits 4Tx on a first carrier (band) via a first Tx chain and 4Tx on a second carrier via a second Tx chain, and a second case, in which the UE transmits 0Tx on the first carrier and 2Tx on the second carrier via both the first and second Tx chains. Based on UE capability, for the first mode, the UE can either transmit according to a first option, in which simultaneous Tx on the first and second carriers is not supported (switchedUL) , or a second mode, in which simultaneous Tx on the first and second carriers is supported (dualUL). In Rel-16/17, the UE can report for one band combination whether the capability switchedUL, dualUL, or both is supported. A gNB can configure the UE for a UL Tx switching scheme for the band combination in accordance with (one of) the reported capability(ies).

In Rel-18, UL Tx switching will be supported for three or four bands. If 3 bands are supported for UL Tx switching, then three possible band combinations (e.g., bands A+B; A+C; B+C) can be configured for the UE for UL Tx switching. If 4 bands are supported for UL Tx switching, then six possible band combinations (bands A+B; A+C; A+D; B+C; B+D; C+D) can be configured for the UE for UL Tx switching. The UE may support simultaneous Tx (for the first mode of UL Tx switching) only on certain ones of the supported bands or band combinations. Additionally, the UE may support 2Tx (for the second mode of UL Tx switching) only on certain ones of the supported bands.

The UE capability reporting and the gNB configuration mechanisms for UL Tx switching, according to current specification, are inadequate for handling these limitations/restrictions for UL Tx switching on 3 or 4 bands. For example, the switchedUL, dualUL and both capabilities from Rel-16/17 assume a 1 -to-1 mapping between only two reported bands. In Rel-18, if certain bands or band combinations from 3 or 4 supported Tx switching bands are restricted/limited from certain UL Tx switching features, the capability reporting and configuration mechanisms for UL Tx switching require enhancements for indicating these restrictions.

### SUMMARY

Some exemplary embodiments are related to a method performed by a user equipment (UE). The method includes reporting UE capability information related to uplink (UL) transmission (Tx) switching to a network, wherein the UE capability information comprises an indication that the UE supports a 3 or 4 band combination for UL Tx switching and an indication that the UE supports simultaneous Tx on at least one two-band combination from the 3 or 4 band combination, receiving, from the network, a UL Tx switching configuration based on at least the UE capability information and performing UL transmissions based on the UL Tx switching configuration.

Other exemplary embodiments are related to a method performed by a base station. The method includes receiving, from a user equipment (UE), UE capability information related to uplink (UL) transmission (Tx) switching, wherein the UE capability information comprises an indication that the UE supports a 3 or 4 band combination for UL Tx switching and an indication that the UE supports simultaneous Tx on at least one two-band combination from the 3 or 4 band combination, determining a UL Tx switching configuration based on at least the UE capability information and transmitting the UL Tx switching configuration to the UE.

Still further exemplary embodiments are related to a method performed by a user equipment (UE). The method includes reporting UE capability information related to uplink (UL) transmission (Tx) switching to a network, wherein the UE capability information comprises an indication that the UE supports a 3 or 4 band combination for UL Tx switching and an indication that the UE does not support two-port Tx (2Tx) on at least one band from the 3 or 4 band combination or at least one two-band combination from the 3 or 4 band combination, receiving, from the network, a UL Tx switching configuration based on at least the UE capability information and performing UL transmissions based on the UL Tx switching configuration.

Additional exemplary embodiments are related to a method performed by a base station. The method includes receiving, from a user equipment (UE), UE capability information related to uplink (UL) transmission (Tx) switching, wherein the UE capability information comprises an indication that the UE supports a 3 or 4 band combination for UL Tx switching and an indication that the UE does not support two-port Tx (2Tx) on at least one band from the 3 or 4 band combination or at least one two-band combination from the 3 or 4 band combination, determining a UL Tx switching configuration based on at least the UE capability information and transmitting the UL Tx switching configuration to the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary signaling diagram for UE capability reporting and network configuration for UL Tx switching for three or four UL bands according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for user equipment (UE) capability reporting and network configuration of uplink (UL) transmission (Tx) switching for three or four UL bands.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a 5G NR network that supports UL Tx switching. However, it should be understood that the exemplary embodiments may be applied to any network that supports UL Tx switching, including further evolutions of the cellular standards (e.g., 6G networks).

Uplink (UL) transmission (Tx) switching was introduced in 3GPP New Radio (NR) Rel-16 to improve UL coverage for 5G user equipment (UE). Some UEs are limited to two UL Tx chains/channels (2Tx), and UL Tx switching allows the UE to switch between a first mode, in which the UE transmits 4Tx on a first carrier (band) via a first Tx chain and 4Tx on a second carrier via a second Tx chain, and a second mode, in which the UE transmits 0Tx on the first carrier and 2Tx on the second carrier via both the first and second Tx chains. For the first mode (1Tx+1Tx), some UEs may be enabled to switch between the first and second bands in a time division multiplexing (TDM) mode (switchedUL), other UEs may be enabled to transmit on both Tx chains simultaneously (dualUL), and still other UEs may be enabled for both the TDM mode and simultaneous Tx (both).

In Rel-16/17, the UE can report for one band combination whether the capability switchedUL, dualUL, or both is supported. No other restrictions/rules/limitations are supported. A gNB can configure the UE for a UL Tx switching scheme for the reported band combination in accordance with (one of) the reported capability (ies). In Rel-17, the UE can additionally report a 2Tx-2Tx switching capability, wherein either the first or second carrier can be transmitted on 2Tx chains in the second mode.

In Rel-18, UL Tx switching will be supported for three or four bands. These four bands are referred to herein as Band A, Band B, Band C and Band D. If 3 bands are supported for UL Tx switching, then three possible band combinations (e. g., bands A+B; A+C; B+C) can be configured for the UE for UL Tx switching. If 4 bands are supported for UL Tx switching, then six possible band combinations (bands A+B; A+C; A+D; B+C; B+D; C+D) can be configured for the UE for UL Tx switching.

Various limitations/restrictions may be imposed for UL Tx switching across 3 or 4 bands. In a first restriction, the UE is allowed to support simultaneous Tx (for the first mode of UL Tx switching) only on certain ones of the supported bands or band combinations. In a second restriction, the UE is allowed to support 2Tx only on certain ones of the supported bands.

The UE capability reporting and the gNB configuration mechanisms for UL Tx switching, according to current specification, are inadequate for handling these limitations/restrictions for UL Tx switching on 3 or 4 bands.

For example, the switchedUL, dualUL and both capabilities from Rel-16/17 assume a 1-to-1 mapping between the capability and the reported band combination. In Rel-18, if certain bands or band combinations from 3 or 4 supported Tx switching bands are restricted/limited from certain UL Tx switching features, the capability reporting and configuration mechanisms for UL Tx switching require enhancements for indicating these restrictions.

According to various aspects of these exemplary embodiments, operations are described for handling the UE capability reporting for UL Tx switching for the agreed restrictions/limitations in combination with various switching modes. Additionally, operations are described for handling the network configuration of the UE for UL Tx switching for the agreed restrictions/limitations in combination with various switching modes.

In one aspect of these exemplary embodiments, the first restriction is considered wherein the UE is allowed to support simultaneous Tx for a subset of band combinations from 3 or 4 bands for UL Tx switching. In these embodiments, the capabilities switchedUL, dualUL, or both can be used for the 3 or 4 bands in a first stage of UL Tx switching capability reporting. In some embodiments, a second stage of UL Tx switching capability reporting can be used to indicate particular band combinations from the 3 or 4 bands that are exceptions to the capability indicated in the first stage.

In some embodiments, the UE can report its capability to support switchedUL, dualUL, or both for a 3 or 4 band combination in a first stage of capability reporting for UL Tx switching. In one scenario, the UE can report its capability to support switchedUL for the 3 or 4 band combination in the first stage. If the UE does not support simultaneous transmission for any of the two band combinations from the 3 or 4 band combination, then the UE does not perform a second stage of capability reporting. If the UE supports simultaneous transmission for any of the two band combinations, then the UE can perform the second stage of capability reporting and additionally report its capability to support dualUL for one or more particular two band combinations. For the band pair(s) for which the UE reports dualUL, the UE is expected to support simultaneous transmission on the carriers of both bands of the band combination.

In another scenario of these exemplary embodiments, the UE can report its capability to support dualUL or both for the 3 or 4 band combination in only a single stage of capability reporting. When dualUL or both is reported, then the UE is expected to support simultaneous transmission on the carriers of both bands for all of the two band pairs from the 3 or 4 band combination.

In other exemplary embodiments, the UE can report its capability to support dualUL or both for the 3 or 4 band combination in a first stage of capability reporting. If the UE supports simultaneous transmission for all of the two band combinations from the 3 or 4 band combination, then the UE does not perform a second stage of capability reporting. If the UE does not support simultaneous transmission for any of the two band combinations, then the UE can perform the second stage of capability reporting and additionally report its capability to not support dualUL for one or more particular two band combinations. For the band pair(s) for which the UE reports no dualUL, the UE is not expected to support simultaneous transmission on the carriers of both bands of the band combination.

In any of the exemplary embodiments discussed above, the UE is able to indicate its capability to support or not support dualUL for one or multiple two band pairs from the 3 or 4 band combination. Based on the reported capabilities, the network can configure the UE to not expect simultaneous Tx on some or all of the reported band combinations, in accordance with the reported capabilities. In some scenarios, the network can configure the UE to not expect simultaneous Tx even on two band combinations for which the UE supports simultaneous Tx.

In some exemplary embodiments, if the gNB does not configure the UE with the above restriction for a band pair for which the UE reported dualUL support, then the UE is expected to support simultaneous transmission on those reported band pairs.

In another aspect of these exemplary embodiments, the second restriction is considered wherein the UE is allowed to support 2Tx for a subset of bands or band combinations from 3 or 4 bands for UL Tx switching. In these embodiments, additional UL Tx switching mode capabilities indicating no support of 2Tx can be reported in addition to the capabilities switchedUL and dualUL. In these embodiments, the new capabilities are referred to as switchedULwithout2T and dualULwithout2T. It should be understood that these new capabilities may be defined with different names, and the terms switchedULwithout2T and dualULwithout2T are used only for ease of explanation.

In some exemplary embodiments, the UL Tx switching capabilities switchedUL, dualUL, switchedULwithout2T and dualULwithout2T can be reported for any one or more of: a 3 or 4 band combination; one or more two band pairs from the 3 or 4 band combination; and one or more bands from the 3 or 4 band combination. The switchedUL capability and the dualUL capability can be the same as currently specified in NR. The switchedULwithout2T capability is similar to switchedUL, but additionally indicates that 2T transmission on a band is not supported. The dualULwithout2T capability is similar to dualUL, but additionally indicates that 2T transmission on a band is not supported.

If any of the above capabilities/restrictions is reported for a specific band, then the restriction applies for any band combination including that band. For example, if a three band combination of Bands A, B and C is reported for UL Tx switching, and a no 2T restriction is reported for Band C, then the band combinations of Bands A+C and Bands B+C are restricted from 2T UL Tx switching. If any of the above restrictions is reported for a specific band pair, then the restriction is applied only to that particular pair rather than any individual bands, e.g., the involved band(s) may have to be paired with another band(s) and may not apply the restriction, unless specifically reported.

The UE can report any of the capabilities/restrictions described above for the 3 or 4 band combination for UL Tx switching.

In some exemplary embodiments, the UE can report switchedUL for the 3 or 4 band combination. When switchedUL is reported for the 3 or 4 band combination, it can be assumed that, for all of the 3 or 4 bands, the UE can be scheduled with 2Tx. In an alternative, the UE can additionally report switchedULwithout2T for a band pair and/or particular bands from the 3 or 4 band combination to exclude these bands or band pairs from 2Tx.

In other exemplary embodiments, the UE can report dualUL for the 3 or 4 band combination. When dualUL is reported for the 3 or 4 band combination, it can be assumed that, for all of the 3 or 4 bands, the UE can be scheduled with 2Tx. In an alternative, the UE can additionally report dualULwithout2T for a band pair and/or particular bands from the 3 or 4 band combination to exclude these bands or band pairs from 2Tx.

In further exemplary embodiments, the UE can report both (switchedUL and dualUL) for the 3 or 4 band combination. When both is reported for the 3 or 4 band combination, it can be assumed that, for all of the 3 or 4 bands, the UE can be scheduled with 2Tx. In an alternative, the UE can additionally report switchedULwithout2T, dualULwithout2T, or both switchedULwithout2T and dualULwithout2T for a band pair and/or particular bands from the 3 or 4 band combination to exclude these bands or band pairs from 2Tx.

In additional exemplary embodiments, the UE can report switchedULwithout2T for the 3 or 4 band combination. In another embodiment, the UE can report dualULwithout2T for the 3 or 4 band combination. In another embodiment, the UE can report both switchedULwithout2T and dualULwithout2T. In any of these cases, (when switchedULwithout2T, dualULwithout2T, or switchedULwithout2T and dualULwithout2T is reported for the 3 or 4 band combination) the UE cannot be scheduled with 2Tx on any of the 3 or 4 bands. Consequently, the UE cannot be triggered/indicated with 2T-2T and 1T-21/2T-1T switching cases for any of the 3 or 4 bands.

In any of the exemplary embodiments discussed above, the UE is able to indicate its capability to support or not support 2Tx for one or multiple two band pairs from the 3 or 4 band combination. Based on the reported capabilities, the network can configure the UE to not expect 2Tx on some or all of the reported bands or band combinations, in accordance with the reported capabilities. In some scenarios, the network can configure the UE to not expect 2Tx even on a band or band combination for which the UE supports 2Tx.

In some exemplary embodiments, if the gNB does not configure the UE with the above restriction for a band or band pair for which the UE reported 2Tx support, then the UE is expected to support 2Tx on those reported band pairs.

It should be understood that the exemplary embodiments described above for UE reporting and configuring the UE with UL Tx switching, in view of the restrictions/limitations described above, can be used alone or in combination.

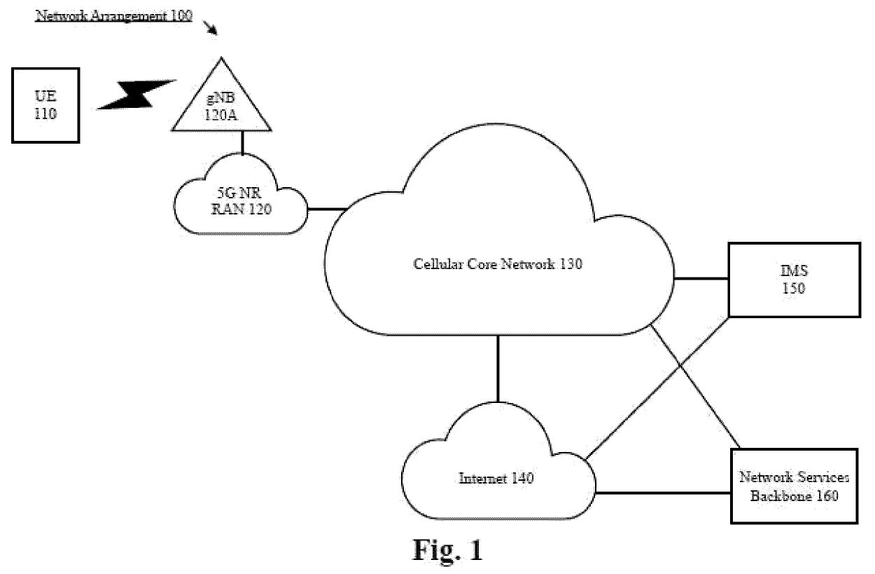

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc. ) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e. g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

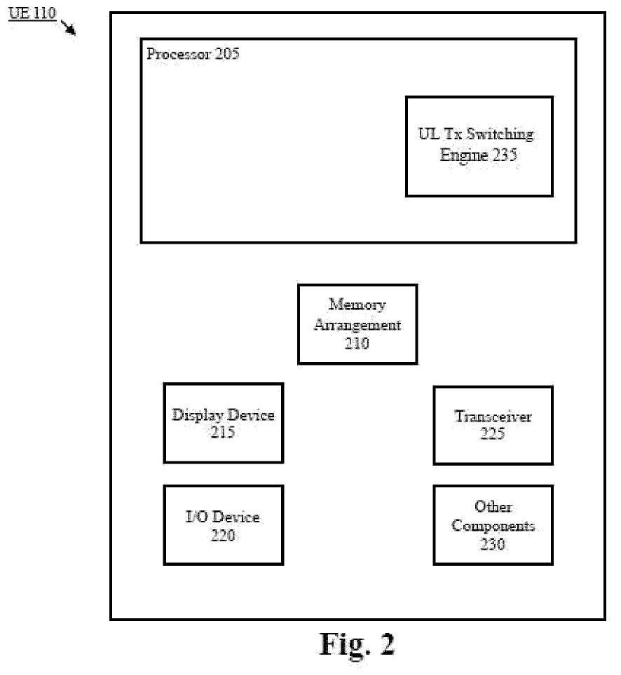

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a UL Tx switching engine 235. The UL Tx switching engine 235 may perform a variety of operations including reporting UE capabilities related to UL Tx switching to the network, receiving a UL Tx switching configuration from the network and implementing the UL Tx switching configuration, as described above.

The above referenced engine 235 being an application (e. g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs.

The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e. g., set of consecutive frequencies).

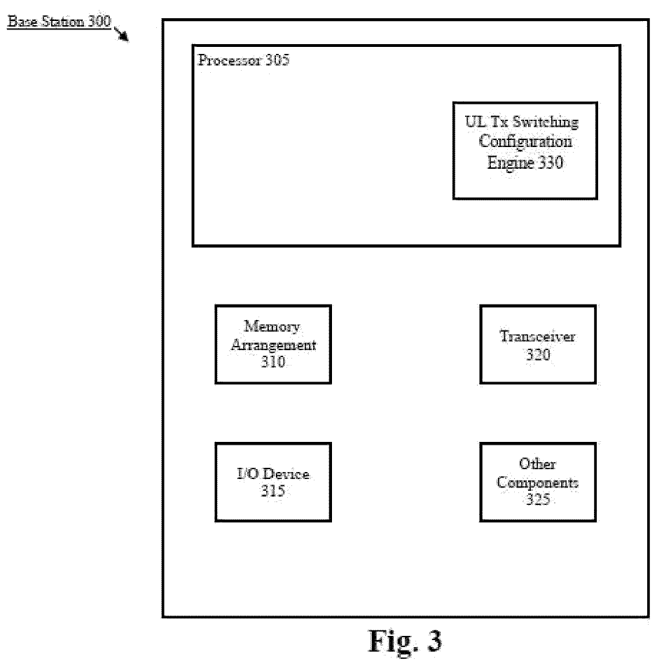

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a UL Tx switching configuration engine 330. The UL Tx switching configuration engine 330 may perform a variety of operations including receiving a report of UE capabilities related to UL Tx switching from the UE 110, determining a UL Tx switching configuration based on the UE capabilities, and sending the UL Tx switching configuration to the UE 110, as described above.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e. g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

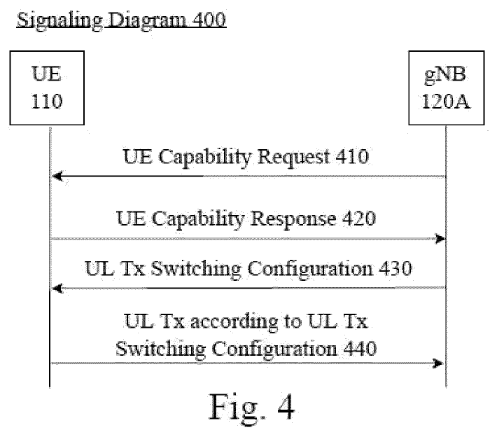

FIG. 4 shows an exemplary signaling diagram for UE capability reporting and network configuration for UL Tx switching for three or four UL bands according to various exemplary embodiments.

In 410, the gNB 120A sends a UE capability request to the UE 110. Typically, the UE capability request may be sent during a registration procedure that the UE 110 is performing with the network. However, the network (via the gNB 120A) may request the UE capability information at any time including when the UE 110 is in a connected state (e.g., RRC Connected) with the network. In this example, the UE capability request will include a request for the UE capabilities related to UL Tx switching.

In 420, the UE 110 will respond to the UE capability request by sending the gNB 120A a UE capability response to inform the network of the UE capabilities. Those skilled in the art will understand that there may be multiple manners of signaling UE capabilities to the network. Any of these manners may be used to signal the capabilities of the UE 110. These capabilities may include the UE capabilities with respect to UL Tx switching described above, e.g., whether simultaneous Tx or 2Tx is supported for all bands and/or two-band combinations from the 3 or 4 band combination, no bands and/or two-band combinations from the 3 or 4 band combination, or some bands and/or two-band combinations from the 3 or 4 band combination.

The gNB 120A, after receiving the UE capability information in 420, may, in 430 configure or indicate to the UE 110 the specific UL Tx switching configuration that the UE 110 should use. This UL Tx switching configuration may comprise information such as the bands/carriers to be used by the UE 110 for UL transmissions and any restrictions/limitations for UL Tx switching, e.g., whether to expect simultaneous Tx or 2Tx for all bands and/or two-band combinations from the 3 or 4 band combination, no bands and/or two-band combinations from the 3 or 4 band combination, or some bands and/or two-band combinations from the 3 or 4 band combination. The UL Tx switching configuration provided in 430 may be sent in any type of message exchange between the gNB 120A and the UE 110, such as, in RRC, DCI, a MAC CE, etc.

In 440, the UE 110 performs the UL transmissions according to the UL Tx switching configuration provided in 430.

### EXAMPLES

In a first example, a processor is configured to report UE capability information related to uplink (UL) transmission (Tx) switching to a network, wherein the UE capability information comprises an indication that the UE supports a 3 or 4 band combination for UL Tx switching and an indication that the UE supports simultaneous Tx on at least one two-band combination from the 3 or 4 band combination, receive, from the network, a UL Tx switching configuration based on at least the UE capability information and perform UL transmissions based on the UL Tx switching configuration.

In a second example, the processor of the first example, wherein the UE capability information comprises a first level, in which the UE does not include capability information on the support of simultaneous Tx for the 3 or 4 band combination, and a second level, in which the UE indicates the UE supports simultaneous Tx for the at least one two-band combination from the 3 or 4 band combination, wherein the UE expects to be configured with simultaneous Tx for the at least one two-band combination and does not expect to be configured with simultaneous Tx for any two-band combination from the 3 or 4 band combination other than the at least one two-band combination for which the UE indicated support of simultaneous Tx.

In a third example, the processor of the first example, wherein the UE capability information indicates the UE supports simultaneous Tx for the 3 or 4 band combination, wherein the UE expects to be configured with simultaneous Tx for each two-band combination from the 3 or 4 band combination.

In a fourth example, the processor of the first example, wherein the UE capability information comprises a first level, in which the UE indicates the UE supports simultaneous Tx for the 3 or 4 band combination, and a second level, in which the UE indicates the UE does not support simultaneous Tx for at least one two-band combination from the 3 or 4 band combination, wherein the UE does not expect to be configured with simultaneous Tx for the at least one two-band combination for which the UE indicated no support for simultaneous Tx and expects to be configured with simultaneous Tx for any two-band combination from the 3 or 4 band combination other than the at least one two-band combination for which the UE indicated no support of simultaneous Tx.

In a fifth example, the processor of the first example, wherein the UL Tx switching configuration comprises an indication that the UE should not expect simultaneous transmission on the at least one two-band combination from the 3 or 4 band combination for which the UE indicated support of simultaneous Tx.

In a sixth example, the processor of the first example, wherein the UL Tx switching configuration does not comprise an indication that the UE should not expect simultaneous transmission on the at least one two-band combination from the 3 or 4 band combination for which the UE indicated support of simultaneous Tx, wherein the UE expects to be configured with simultaneous Tx for the at least one two-band combination and does not expect to be configured with simultaneous Tx for any two-band combination from the 3 or 4 band combination other than the at least one two-band combination for which the UE indicated support of simultaneous Tx.

In a seventh example, the processor of the first example, wherein the UE capability information does not indicate information on support of simultaneous Tx for the 3 or 4 band combination in a first level and does not indicate information on support of simultaneous Tx for any band pair from the 3 or 4 band combination, then the UE does not expect to be configured with simultaneous Tx on any band pair from the 3 or 4 band combination.

In an eighth example, a user equipment comprises a transceiver configured to communicate with a network and the processor of any of the first through seventh examples.

In a ninth example, a processor is configured to receive, from a user equipment (UE), UE capability information related to uplink (UL) transmission (Tx) switching, wherein the UE capability information comprises an indication that the UE supports a 3 or 4 band combination for UL Tx switching and an indication that the UE supports simultaneous Tx on at least one two-band combination from the 3 or 4 band combination, determine a UL Tx switching configuration based on at least the UE capability information and transmit the UL Tx switching configuration to the UE.

In a tenth example, the processor of the ninth example, wherein the UE capability information comprises a first level, in which the UE indicates the UE does not support simultaneous Tx for the 3 or 4 band combination, and a second level, in which the UE indicates the UE supports simultaneous Tx for the at least one two-band combination from the 3 or 4 band combination, wherein the UE is expected by the base station to support simultaneous Tx for the at least one two-band combination and is not expected by the base station to support simultaneous Tx for any two-band combination from the 3 or 4 band combination other than the at least one two-band combination for which the UE indicated support of simultaneous Tx.

In an eleventh example, the processor of the ninth example, wherein the UE capability information indicates the UE supports simultaneous Tx for the 3 or 4 band combination, wherein the UE is expected by the base station to support simultaneous Tx for each two-band combination from the 3 or 4 band combination.

In a twelfth example, the processor of the ninth example, wherein the UE capability information comprises a first level, in which the UE indicates the UE supports simultaneous Tx for the 3 or 4 band combination, and a second level, in which the UE indicates the UE does not support simultaneous Tx for at least one two-band combination from the 3 or 4 band combination, wherein the UE is not expected by the base station to support simultaneous Tx for the at least one two-band combination for which the UE indicated no support for simultaneous Tx and is expected by the base station to support simultaneous Tx for any two-band combination from the 3 or 4 band combination other than the at least one two-band combination for which the UE indicated no support of simultaneous Tx.

In a thirteenth example, the processor of the ninth example, wherein the base station determines to not configure simultaneous Tx on the at least one two-band combination from the 3 or 4 band combination for which the UE indicated support of simultaneous Tx, wherein the UL Tx switching configuration comprises an indication that the UE should not expect simultaneous transmission on the at least one two-band combination from the 3 or 4 band combination for which the UE indicated support of simultaneous Tx.

In a fourteenth example, the processor of the ninth example, wherein the base station refrains from indicating that the UE should not expect simultaneous transmission on the at least one two-band combination from the 3 or 4 band combination for which the UE indicated support of simultaneous Tx, wherein the base station expects the UE to support simultaneous Tx for the at least one two-band combination and does not expect the UE to support simultaneous Tx for any two-band combination from the 3 or 4 band combination other than the at least one two-band combination for which the UE indicated support of simultaneous Tx.

In a fifteenth example, a base station comprises a transceiver configured to communicate with a network and the processor of any of the ninth through fourteenth examples.

In a sixteenth example, a processor is configured to report UE capability information related to uplink (UL) transmission (Tx) switching to a network, wherein the UE capability information comprises an indication that the UE supports a 3 or 4 band combination for UL Tx switching and an indication that the UE does not support two-port Tx (2Tx) on at least one band from the 3 or 4 band combination or at least one two-band combination from the 3 or 4 band combination, receive, from the network, a UL Tx switching configuration based on at least the UE capability information and perform UL transmissions based on the UL Tx switching configuration.

In a seventeenth example, the processor of the sixteenth example, wherein the UE capability information indicates the UE supports 2Tx for the 3 or 4 band combination, wherein the UE expects to be configured with 2Tx for any band or two-band combination from the 3 or 4 band combination.

In an eighteenth example, the processor of the sixteenth example, wherein the UE capability information comprises a first level, in which the UE indicates the UE supports 2Tx for the 3 or 4 band combination, and a second level, in which the UE indicates the UE does not support 2Tx for the at least one band or two-band combination from the 3 or 4 band combination, wherein the UE does not expect to be configured with 2Tx for the at least one band or two-band combination from the 3 or 4 band combination and expects to be configured with 2Tx for any band or two-band combination from the 3 or 4 band combination other than the at least one band or two-band combination for which the UE indicated no support 2Tx.

In a nineteenth example, the processor of the sixteenth example, wherein the UE capability information indicates the UE does not support 2Tx for a particular band from the 3 or 4 band combination, wherein the UE does not expect to be configured with 2Tx for the particular band or any two-band combination from the 3 or 4 band combination including the particular band.

In a twentieth example, the processor of the sixteenth example, wherein the UE capability information indicates the UE does not support 2Tx for a particular two-band combination from the 3 or 4 band combination, wherein the UE does not expect to be configured with 2Tx for the particular two-band combination and expects to be configured with 2Tx for any other two-band combination from the 3 or 4 band combination other than the particular two-band combination.

In a twenty first example, the processor of the sixteenth example, wherein the UL Tx switching configuration comprises an indication that the UE should not expect 2Tx on the at least one band or two-band combination from the 3 or 4 band combination for which the UE indicated support of 2Tx.

In a twenty second example, the processor of the sixteenth example, wherein the UL Tx switching configuration does not comprise an indication that the UE should not expect 2Tx on the at least one band or two-band combination from the 3 or 4 band combination for which the UE indicated support of simultaneous Tx, wherein the UE expects to be configured with 2Tx for the at least one band or two-band combination for which the UE indicated support of 2Tx and does not expect to be configured with 2Tx for any band or two-band combination from the 3 or 4 band combination other than the at least one band or two-band combination for which the UE indicated support of 2Tx.

In an twenty third example, a user equipment comprises a transceiver configured to communicate with a network and the processor of any of the sixteenth through twenty second examples.

In a twenty fourth example, a method is performed by a base station, comprising receiving, from a user equipment (UE), UE capability information related to uplink (UL) transmission (Tx) switching, wherein the UE capability information comprises an indication that the UE supports a 3 or 4 band combination for UL Tx switching and an indication that the UE does not support two-port Tx (2Tx) on at least one band from the 3 or 4 band combination or at least one two-band combination from the 3 or 4 band combination, determining a UL Tx switching configuration based on at least the UE capability information and transmitting the UL Tx switching configuration to the UE.

In a twenty fifth example, the method of the twenty fourth example, wherein the UE capability information indicates the UE supports 2Tx for the 3 or 4 band combination, wherein the base station expects the UE to support 2Tx for any band or two-band combination from the 3 or 4 band combination.

In a twenty sixth example, the method of the twenty fourth example, wherein the UE capability information comprises a first level, in which the UE indicates the UE supports 2Tx for the 3 or 4 band combination, and a second level, in which the UE indicates the UE does not support 2Tx for the at least one band or two-band combination from the 3 or 4 band combination, wherein the base station does not expect the UE to support 2Tx for the at least one band or two-band combination from the 3 or 4 band combination and expects the UE to support 2Tx for any band or two-band combination from the 3 or 4 band combination other than the at least one band or two-band combination for which the UE indicated no support 2Tx.

In a twenty seventh example, the method of the twenty fourth example, wherein the UE capability information indicates the UE does not support 2Tx for a particular band from the 3 or 4 band combination, wherein the base station does not expect the UE to support 2Tx for the particular band or any two-band combination from the 3 or 4 band combination including the particular band.

In a twenty eighth example, the method of the twenty fourth example, wherein the UE capability information indicates the UE does not support 2Tx for a particular two-band combination from the 3 or 4 band combination, wherein the base station does not expect the UE to support 2Tx for the particular two-band combination and expects the UE to support 2Tx for any other two-band combination from the 3 or 4 band combination other than the particular two-band combination.

In a twenty ninth example, the method of the twenty fourth example, wherein the base station determines to not configure 2Tx on any band or two-band combination from the 3 or 4 band combination for which the UE indicated support of 2Tx, wherein the UL Tx switching configuration comprises an indication that the UE should not expect 2Tx on the band or two-band combination from the 3 or 4 band combination for which the UE indicated support of 2Tx.

In a thirtieth example, the method of the twenty fourth example, wherein the base station refrains from indicating that the UE should not expect 2Tx on any band or two-band combination from the 3 or 4 band combination for which the UE indicated support of 2Tx, wherein the base station expects the UE to support 2Tx for the band or two-band combination for which the UE indicated support of 2Tx and does not expect the UE to support 2Tx for the at least one band or two-band combination from the 3 or 4 band combination for which the UE indicated no support of 2Tx.

In a thirty first example, a processor configured to perform any method of the twenty fourth through thirtieth examples.

In a thirty second example, a base station comprises a transceiver configured to communicate with a network and a processor configured to perform any method of the twenty fourth through thirtieth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
reporting UE capability information related to uplink (UL) transmission (Tx) switching to a network, wherein the UE capability information comprises an indication that the UE supports a 3 or 4 band combination for UL Tx switching and an indication that the UE supports simultaneous Tx on at least one two-band combination from the 3 or 4 band combination;
receiving, from the network, a UL Tx switching configuration based on at least the UE capability information; and
performing UL transmissions based on the UL Tx switching configuration.

2. The method of claim 1, wherein the UE capability information comprises a first level, in which the UE does not include capability information on support of simultaneous Tx for the 3 or 4 band combination, and a second level, in which the UE indicates the UE supports simultaneous Tx for the at least one two-band combination from the 3 or 4 band combination,
wherein the UE expects to be configured with simultaneous Tx for the at least one two-band combination and does not expect to be configured with simultaneous Tx for any two-band combination from the 3 or 4 band combination other than the at least one two-band combination for which the UE indicated support of simultaneous Tx.

3. The method of claim 1, wherein the UE capability information indicates the UE supports simultaneous Tx for the 3 or 4 band combination,
wherein the UE expects to be configured with simultaneous Tx for each two-band combination from the 3 or 4 band combination.

4. The method of claim 1, wherein the UE capability information comprises a first level, in which the UE indicates the UE supports simultaneous Tx for the 3 or 4 band combination, and a second level, in which the UE indicates the UE does not support simultaneous Tx for at least one two-band combination from the 3 or 4 band combination,
wherein the UE does not expect to be configured with simultaneous Tx for the at least one two-band combination for which the UE indicated no support for simultaneous Tx and expects to be configured with simultaneous Tx for any two-band combination from the 3 or 4 band combination other than the at least one two-band combination for which the UE indicated no support of simultaneous Tx.

5. The method of claim 1, wherein the UL Tx switching configuration comprises an indication that the UE is not to expect simultaneous transmission on the at least one two-band combination from the 3 or 4 band combination for which the UE indicated support of simultaneous Tx.

6. The method of claim 1, wherein the UL Tx switching configuration does not comprise an indication that the UE is not to expect simultaneous transmission on the at least one two-band combination from the 3 or 4 band combination for which the UE indicated support of simultaneous Tx,
wherein the UE expects to be configured with simultaneous Tx for the at least one two-band combination and does not expect to be configured with simultaneous Tx for any two-band combination from the 3 or 4 band combination other than the at least one two-band combination for which the UE indicated support of simultaneous Tx.

7. The method of claim 1, wherein the UE capability information does not indicate information on support of simultaneous Tx for the 3 or 4 band combination in a first level and does not indicate information on support of simultaneous Tx for any band pair from the 3 or 4 band combination, then the UE does not expect to be configured with simultaneous Tx on any band pair from the 3 or 4 band combination.

8. A method performed by a base station, comprising:
receiving, from a user equipment (UE), UE capability information related to uplink (UL) transmission (Tx) switching, wherein the UE capability information comprises an indication that the UE supports a 3 or 4 band combination for UL Tx switching and an indication that the UE supports simultaneous Tx on at least one two-band combination from the 3 or 4 band combination;
determining a UL Tx switching configuration based on at least the UE capability information; and
transmitting the UL Tx switching configuration to the UE.

9. The method of claim 8, wherein the UE capability information comprises a first level, in which the UE indicates the UE does not support simultaneous Tx for the 3 or 4 band combination, and a second level, in which the UE indicates the UE supports simultaneous Tx for the at least one two-band combination from the 3 or 4 band combination,
wherein the UE is expected by the base station to support simultaneous Tx for the at least one two-band combination and is not expected by the base station to support simultaneous Tx for any two-band combination from the 3 or 4 band combination other than the at least one two-band combination for which the UE indicated support of simultaneous Tx.

10. The method of claim 8, wherein the UE capability information indicates the UE supports simultaneous Tx for the 3 or 4 band combination,
wherein the UE is expected by the base station to support simultaneous Tx for each two-band combination from the 3 or 4 band combination.

11. The method of claim 8, wherein the UE capability information comprises a first level, in which the UE indicates the UE supports simultaneous Tx for the 3 or 4 band combination, and a second level, in which the UE indicates the UE does not support simultaneous Tx for at least one two-band combination from the 3 or 4 band combination,
wherein the UE is not expected by the base station to support simultaneous Tx for the at least one two-band combination for which the UE indicated no support for simultaneous Tx and is expected by the base station to support simultaneous Tx for any two-band combination from the 3 or 4 band combination other than the at least one two-band combination for which the UE indicated no support of simultaneous Tx.

12. The method of claim 8, wherein the base station determines to not configure simultaneous Tx on the at least one two-band combination from the 3 or 4 band combination for which the UE indicated support of simultaneous Tx,
wherein the UL Tx switching configuration comprises an indication that the UE is not to expect simultaneous transmission on the at least one two-band combination from the 3 or 4 band combination for which the UE indicated support of simultaneous Tx.

13. The method of claim 8, wherein the base station refrains from indicating that the UE is not to expect simultaneous transmission on the at least one two-band combination from the 3 or 4 band combination for which the UE indicated support of simultaneous Tx,
wherein the base station expects the UE to support simultaneous Tx for the at least one two-band combination and does not expect the UE to support simultaneous Tx for any two-band combination from the 3 or 4 band combination other than the at least one two-band combination for which the UE indicated support of simultaneous Tx.

14. A method performed by a user equipment (UE), comprising:
reporting UE capability information related to uplink (UL) transmission (Tx) switching to a network, wherein the UE capability information comprises an indication that the UE supports a 3 or 4 band combination for UL Tx switching and an indication that the UE does not support two-port Tx (2Tx) on at least one band from the 3 or 4 band combination or at least one two-band combination from the 3 or 4 band combination;
receiving, from the network, a UL Tx switching configuration based on at least the UE capability information; and
performing UL transmissions based on the UL Tx switching configuration.

15. The method of claim 14, wherein the UE capability information indicates the UE supports 2Tx for the 3 or 4 band combination,
wherein the UE expects to be configured with 2Tx for any band or two-band combination from the 3 or 4 band combination.

16. The method of claim 14, wherein the UE capability information comprises a first level, in which the UE indicates the UE supports 2Tx for the 3 or 4 band combination, and a second level, in which the UE indicates the UE does not support 2Tx for the at least one band or two-band combination from the 3 or 4 band combination,
wherein the UE does not expect to be configured with 2Tx for the at least one band or two-band combination from the 3 or 4 band combination and expects to be configured with 2Tx for any band or two-band combination from the 3 or 4 band combination other than the at least one band or two-band combination for which the UE indicated no support 2Tx.

17. The method of claim 14, wherein the UE capability information indicates the UE does not support 2Tx for a particular band from the 3 or 4 band combination, wherein the UE does not expect to be configured with 2Tx for the particular band or any two-band combination from the 3 or 4 band combination including the particular band.

18. The method of claim 14, wherein the UE capability information indicates the UE does not support 2Tx for a particular two-band combination from the 3 or 4 band combination,
wherein the UE does not expect to be configured with 2Tx for the particular two-band combination and expects to be configured with 2Tx for any other two-band combination from the 3 or 4 band combination other than the particular two-band combination.

19. The method of claim 14, wherein the UL Tx switching configuration comprises an indication that the UE is not to expect 2Tx on the at least one band or two-band combination from the 3 or 4 band combination for which the UE indicated support of 2Tx.

20. The method of claim 14, wherein the UL Tx switching configuration does not comprise an indication that the UE is not to expect 2Tx on the at least one band or two-band combination from the 3 or 4 band combination for which the UE indicated support of simultaneous Tx,
wherein the UE expects to be configured with 2Tx for the at least one band or two-band combination for which the UE indicated support of 2Tx and does not expect to be configured with 2Tx for any band or two-band combination from the 3 or 4 band combination other than the at least one band or two-band combination for which the UE indicated support of 2Tx.
